(19) United States
(12) Patent Application Publication
(10) Pub. No.: US 2018/0129164 A1
(43) Pub. Date: May 10, 2018

(54) INFORMATION SYSTEM WITH HOLOGRAM DISPLAY

(71) Applicant: Ewig Industries Macao Commercial Offshore Limited, Hong Kong (CN)

(72) Inventor: Luk Wah Jackson CHU, Hong Kong (CN)

(21) Appl. No.: 15/346,889

(22) Filed: Nov. 9, 2016

(51) Int. Cl. G03H 1/00; G03H 1/02; G03H 1/22

(52) U.S. Cl. CPC G03H 1/0005; G03H 1/0272; G03H 1/2249; G03H 2226/04; G03H 2227/05; G03H 2270/14; G03H 2270/32; G03H 2001/2284

(57) ABSTRACT

An information display may include a top housing, a bottom housing, and a back housing. The top housing may include a first display that displays information for presentation to the user. The information may be reflected off of a transparent substrate located within a space defined by the top, bottom, and back housing, such that the information appears to the user as a hologram at a virtual plane.

### BACKGROUND

Society is continually becoming more and more information dependent. A device, such as a user's smartphone, provides detailed information such as contacts, time, weather, calendar information etc. Users are able to stream nearly any information through their smartphones. However, a user does not always desire to look at their smartphone for such information.

### SUMMARY OF THE INVENTION

In an embodiment, an information system with hologram display, includes: a top housing; a bottom housing; a back housing; and, a transparent surface disposed between the top housing and bottom housing adjacent the back housing. The information system may be configured such that interior surfaces of each of the top housing, bottom housing, back housing and transparent surface form an interior space. The interior space may display a hologram display therein for presenting information to a viewer.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts an exemplary information system with hologram display, in embodiments.

FIG. 2 depicts a cross section of information system taken along section line A-A′, in embodiments.

FIG. 3 depicts the electronics of FIG. 2 in more exemplary detail, in embodiments.

FIG. 4 depicts an exemplary interactive external device, in embodiments.

FIG. 5 depicts additional exemplary details of the interactive external device, of FIG. 4, in embodiments.

### DETAILED DESCRIPTION OF THE EMBODIMENTS

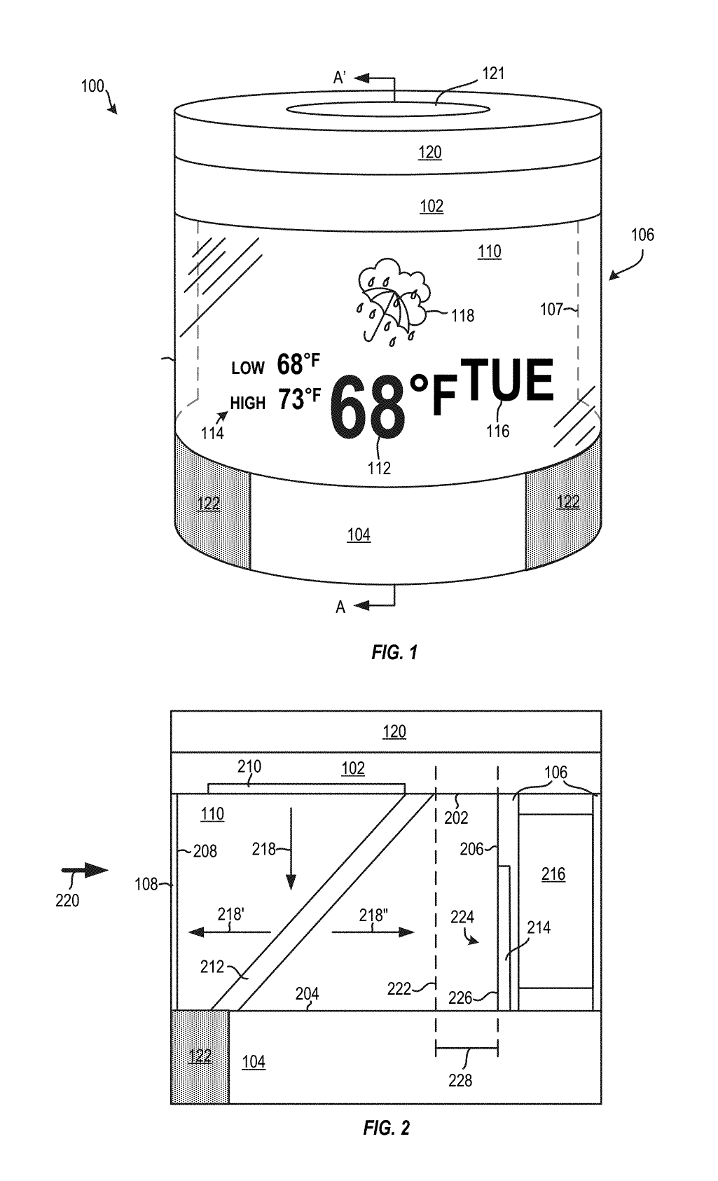

FIG. 1 depicts an exemplary information system 100 with hologram display, in embodiments. FIG. 2 depicts a cross section of information system 100 taken along section line A-A′, in embodiments. FIGS. 1-2 are best viewed together with the following description.

Information system 100 includes top housing 102, bottom housing 104, and back housing 106 coupling top housing 102 to bottom housing 104. Back housing 106 is, for example, indicated where dashed lines 107 are present. Also coupling top housing 102 to bottom housing 104 is a transparent surface 108. Transparent surface 108 is made from, glass, plastic, or other transparent material such that a user can view within the space 110 defined by the interior surfaces of top housing 102, bottom housing 104, back housing 106 and transparent surface 108. In embodiments, information system 100 may further include a light 120, such as a mood light or other configurable light source, and one or more speakers 122. Transparent surface 108 may be cylindrical, or planar, or any other shape without departing from the scope hereof.

Information system 100 operates to display a hologram within interior space 110. For example, as shown in FIG. 1, a hologram of the current temperature 112, the high and low temperature 114, the day of the week 116, and a weather designation symbol 118 are displayed. It should be appreciated that any information may be displayed in the form of a hologram within interior space 110 without departing from the scope hereof.

As shown in FIG. 2, interior space 110 is defined by first interior surface 202 of top housing 102, second interior surface 204 of bottom housing 104, third interior surface 206 of back housing 106, and fourth interior surface 208 of transparent surface 108. The hologram within interior space 110 is generated via a first display 210, a substrate 212, optionally a second display 214, and electronics 216. Each of first display 210 and second display 214, if included, are controlled via electronics 216.

First display 210 may comprise an LCD, LED, plasma, or any other form of electronic display device. Substrate 212 may be a glass, plastic, or other transparent synthetic device. First display 210 is mounted on (or within) top housing 102 and configured to display downward towards substrate 212. In embodiments, substrate 212 comprises transparent acrylonitrile butadiene styrene (ABS) material. Second display 214 may comprise an LCD, LED, plasma, or any other form of electronic display device. Second display 214, if included, is mounted on (or within) back housing 106 and configured to display forward towards substrate 212. It should be appreciated that the configuration of information system 100 may be modified without departing from the scope hereof. For example, first display 210 may be mounted on bottom housing 104, or at an angle depending on the expected viewing angle.

Electronics 216 control first display 210 to generate an image 218 thereon. Image 218, indicated by an arrow in FIG. 2, is incident on substrate 212. Image 218 is then reflected to the user as image 218′ and appears to the user as transmitted as virtual image 218″ by substrate 212 as a virtual image along first plane 222. Therefore, image 218 appears as a hologram to a viewer looking through the front of transparent surface 108 (e.g. according to arrow 220 within FIG. 2). The hologram appears to be at plane 222 to the viewer. Given that the substrate 212 (which may be transparent acrylic, glass, or ABS) is mounted at 45 degree tilting angle (such that the critical angle of the reflector materials selected for substrate 212 provides total internal reflection of image 218′), the distance between the first display 210 and the substrate 212 is equal to the distance between the substrate 212 and the plane 222. These distances may vary based on the angle of substrate 212. Therefore, in embodiments, it should be appreciated that substrate 212 material is chosen to have a refractive index greater than air such that the image is viewed at plane 222 based upon total internal reflection of the image displayed by first display 210 and reflected via substrate 212.

If second display 214 is included, electronics 216 may control second display 214 to generate a second image 224. Second image 224 displays at second plane 226. The distance between first plane 222 and second plane 226 may be optimized such that the hologram displayed within interior space 110 appears to the viewer to have a depth of field. For example, the distance 228 between first plane 222 and second plane 226 may be 10 mm. It should be appreciated that other distances may be used without departing from the scope hereof. First image 218 and second image 224 are configured to display various portions of the overall image seen by the viewer.

Electronics 216 may further operate to control light 120. For example, if light 120 is a mood light, electronics 216 may operate to control the light 120 to display at a specific color. As such, it should be appreciated that light 120 may be one or more light elements configurable to a specific color, such as one or more variable LEDs. Light 120 may further be configured based on the information displayed within interior space 110. For example, if information display 100 operates as an alarm clock, electronics 216 may operate light to flash at a given color, and then display “wake up” or some other information to the viewer.

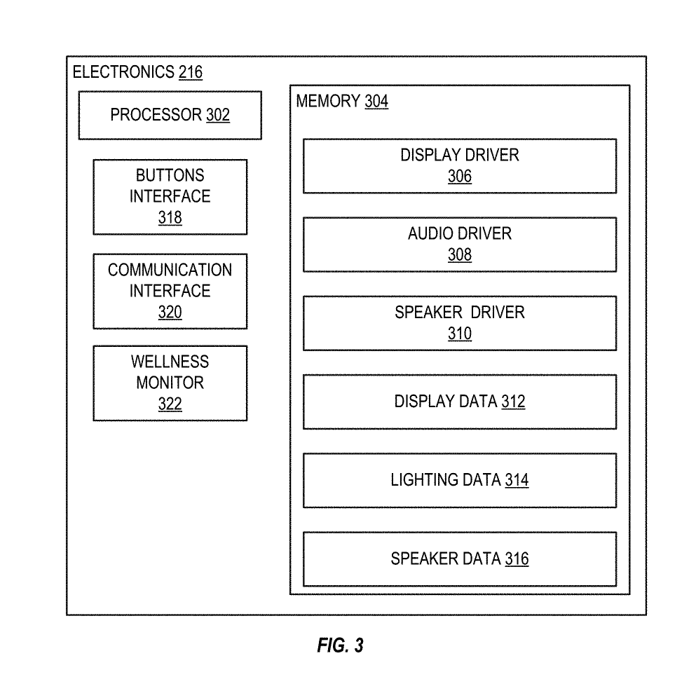

FIG. 3 depicts electronics 216 of FIG. 2 in more exemplary detail, in embodiments. Electronics 216 includes a processor 302 in communication with memory 304. Memory 304 may store one or more of a display diver 306, lighting driver 308, and audio driver 310. Each of the display diver 306, lighting driver 308, and audio driver 310 may comprise computer readable instructions that when executed by processor 302 implement the functionality thereof.

For example, display driver 306 may comprise instructions for controlling operation one or both of first and second displays 210, 214. In one such example, when executed by processor 302, display driver 306 accesses display data 312, stored within memory 304, to control first display 210, and optionally second display 214. For example, in an embodiment, display driver 306 may operate such that first display 210 displays animated icons, scrolling texts, or alert messages (e.g. NOAA) which are related to weather forecast and/or indoor air quality (IAQ). Furthermore, in such embodiment, second display 210 may provide date, time, indoor temperature and humidity information, or otherwise static information.

Additionally, lighting driver 308 may comprise instructions for controlling operation of light 120. In one such example, when executed by processor 302, lighting driver 308 accesses lighting data 314, stored within memory 304, to control light 120. Lighting data 312 may, for example, indicate a given wavelength to emit by light 120.

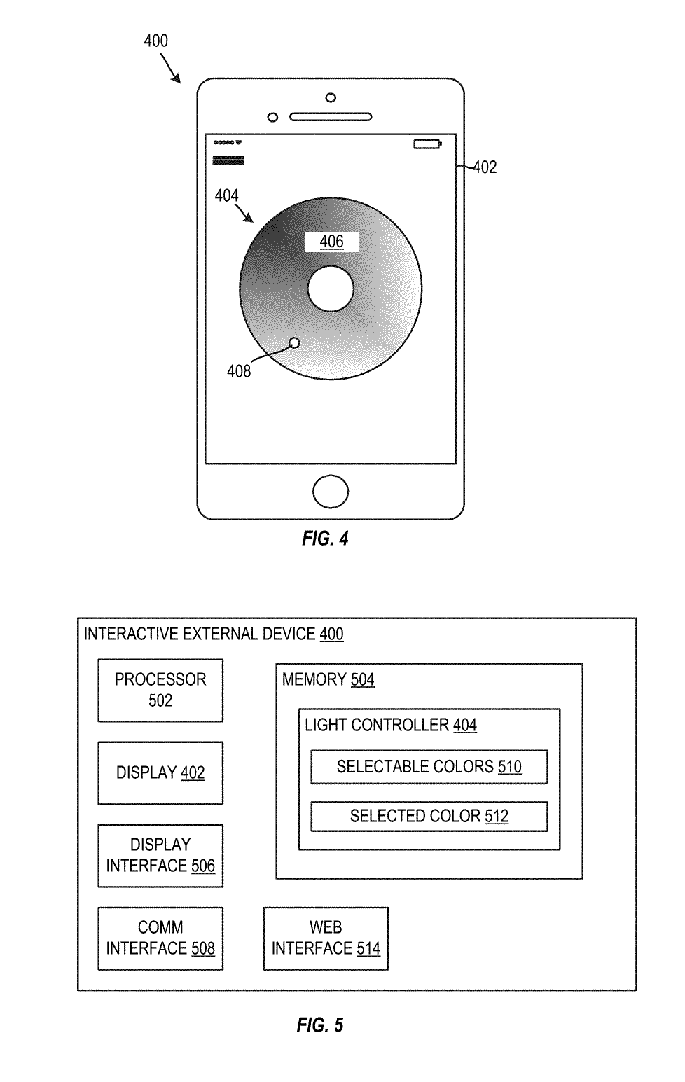

FIG. 4 depicts an exemplary interactive external device 400, in embodiments. Interactive external device 400 includes an application displayed to user via a display 402. It should be appreciated that interactive external device 400 may be any device capable of communicating with information system (i.e. information system 100) via a communications interface (i.e. communications interface 320). Display 402 is shown running an application including a light controller 404. Light controller 404 includes a color “wheel” 406 and a selector 408. A user interacts with selector 408 to select a desired color from color wheel 406. In response, interactive external device 400 transmits the selected color to information system 100 via communications interface 320 for storage as lighting data 314.

FIG. 5 depicts additional exemplary details of the interactive external device 400, of FIG. 4, in embodiments. Interactive external device 400 includes a processor 502 in communication with memory 504, display 402, display interface 506, and a communications interface 512. Memory 504 may store computer readable instructions that, when executed by processor 502, enable the functionality of interactive external device 400 discussed herein. For example, light controller 404 may be stored within memory 504 as such computer readable instructions. Light controller 404 may include a list of selectable colors 510 that are displayed on display 402, for example as color wheel 406 as shown in FIG. 4.

A user may then interact with display interface 506 to select a color within the selectable colors 510. This selection is then stored in memory as selected color 512. Display interface 506 may be, for example, a touch screen portion of display 402, or a mouse, keyboard, or other input device such that a user may interact with interactive external device 400 to select selected color 512.

Once the selected color 512 is stored, processor 502 enables communication interface 508 to obtain a communication link between communications interface 508 and communications interface 320, of information system 100. Upon establishment of communication link between communications interface 508 and communications interface 320, the selected color 512 is transmitted from interactive external device 400 to information system 100 for storage as lighting data 314.

Interactive external device 400 may further include a web interface 514 for obtaining additional information to transmit to information system 100. For example, web interface 514 may be used to obtain clock, video, image, weather, stock, calendar, news headlines, public alerts, Rich-Site Summary (RSS), National Oceanic and Atmospheric Administration (NOAA), web-based information, or other information which may be transmitted to information system via communications interface 508.

Referring back to FIG. 3, speaker driver 310 may comprise instructions for controlling operation of the one or more speakers 122. In one such example, when executed by processor 302, speaker driver 310 accesses speaker data 316, stored within memory 304, to control speaker 122. Speaker data 316 may, for example, be one or more audio files for play by speaker 122.

Electronics 216 may further include buttons interface 318. Buttons interface 318 interacts with buttons on back housing 106. Accordingly, a user may interact with the buttons, and thereby buttons interface 318 to control operation of information system 100. For example, by interaction with buttons interface 318, a user may initiate one or more of display driver 306, audio driver 308, and speaker driver 310.

Electronics 216 may further include communication interface 320. Communication interface 320 may be a wired or wireless communications interface that receives information for an external device. For example, in embodiments, communications interface 320 may be a USB, lighting USB, mini USB, coaxial, or other cable wired interface. In embodiments, communications interface 320 may be a Bluetooth, low-energy Bluetooth, WiFi, cellular, or other wireless interface capable of receiving data from an external device. The external device may be, for example, a smart phone, smart watch, computer, tablet, or other electronic device capable of connection to system 100 via communications interface 320.

In embodiments, electronics 216 may further include an external device charging port. In embodiments, the external device charging port may be a USB port, such as a USB 2.0, 3.0. 3.1, etc. In embodiments, the external device charging port may be a wireless charging port capable of inductive coil and/or magnetic charging methods. It should be appreciated that external device charging port may be accessible to the user on the outside of information system 100. For example, referring to FIG. 1, one or more of top housing 102, bottom housing 104, and back housing 106 may include the external device charging port, such as a USB port. In embodiments including a wireless charging port, the wireless charging port may be located in top housing 102, or if light 120 is included, within light 120. For example, FIG. 1 depicts an exemplary wireless charging port 121 located in the middle of light 120. As such, a user may place an external device, such as a smartphone, capable of wireless charging on top of the wireless charging port 121, while light 120 can radiate outward enabling use of both components of system 100.

In embodiments, a user may stream data from the external device to the system 100 for controlling operation thereof. For example, an external device may transmit clock, video, image, weather, stock, calendar, news headlines, public alerts, Rich-Site Summary (RSS), National Oceanic and Atmospheric Administration (NOAA), web-based information, or other information from the external device to system 100 via communication interface 320 for presentation to the user via one or more of display as a hologram within space 110, playback over speaker 122, or manipulation of light 120.

Electronics 216 may additionally include a wellness monitor 322. Wellness monitor 322 may be, for example, an indoor air quality sensor for sensing fine particulate matter (e.g. PM_{2.5}, PM₁₀), volatile organic compounds (VOC), CO, and CO₂ levels near information system 100. Information obtained from wellness monitor 322 may be stored as display data 312, lighting data 314, or speaker data 316 for identification to the user of information system 100. For example, if wellness monitor 322 detects dangerous levels of CO, or other monitored particulates, information system 100 may respond by performing one or more of the following actions: displaying display data 312 indicating the dangerous levels of CO or other monitored particulates as a hologram within internal space 110; generating speaker data 316 indicating the dangerous levels of CO or other monitored particulates; and displaying lighting data 314 via light 120 as an indication of dangerous levels of CO or other monitored particulates.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An information system with hologram display, comprising:
a top housing;
a bottom housing;
a back housing; and,
a transparent surface disposed between the top housing and bottom housing adjacent the back housing;
interior surfaces of each of the top housing, bottom housing, back housing and transparent surface forming an interior space, the interior space having a hologram display therein for presenting information to a viewer.

2. The information system of claim 1, the hologram display comprising:
an angled transparent substrate, and a first display located in the top housing;
information displayed by the first display being transmitted by the angled transparent substrate forming a virtual image at a first plane.

3. The information system of claim 2, the angled transparent substrate comprising a transparent acrylonitrile butadiene styrene (ABS) substrate.

4. The information system of claim 2, the hologram display comprising a second display located in the back housing.

5. The information system of claim 4, additional information displayed by the second display forming an additional image at a second plane, the second plane different than the first plane.

6. The information system of claim 5, a distance between the first and second plane optimized to provide a depth of field in the combined information and additional information.

7. The information system of claim 1, further comprising a light configurable to a desired color.

8. The information system of claim 7, the light located above the top housing.

9. The information system of claim 1, further comprising a speaker located in the bottom housing.

10. The information system of claim 1, further comprising electronics for controlling at least one of a light, a speaker, and the hologram display.

11. The information system of claim 1, further comprising a communication interface for receiving data from an external device.

12. The information system of claim 11, the data comprising display data for display as the hologram display.

13. The information system of claim 11, the data comprising lighting data for controlling a light.

14. The information system of claim 13, the lighting data comprising a selected color indication received, via a communications interface, from an interactive external device.

15. The information system of claim 11, the data comprising speaker data for playback by a speaker.

16. The information system of claim 11, the data comprising at least one of clock, video, image, weather, stock, calendar, news headlines, public alerts, Rich-Site Summary (RSS), National Oceanic and Atmospheric Administration (NOAA), and web-based information.

17. The information system of claim 1, further comprising a wellness monitor for monitoring air quality proximate the information system.

18. The information system of claim 17, the wellness monitor comprising one or more of a fine particulate matter sensor, volatile organic compounds (VOC) sensor, a CO sensor, and a CO₂ sensor.
